(19) United States
(12) Patent Application Publication
(10) Pub. No.: US 2013/0023166 A1
(43) Pub. Date: Jan. 24, 2013

(54) SILVER PLATED ELECTRICAL CONTACT

(71) Applicants: ZHENGWEI LIU, HERSHEY, PA (US); ROBERT DANIEL HILTY, HARRISBURG, PA (US)

(72) Inventors: ZHENGWEI LIU, HERSHEY, PA (US); ROBERT DANIEL HILTY, HARRISBURG, PA (US)

(73) Assignee: TYCO ELECTRONICS CORPORATION, BERWYN, PA (US)

(21) Appl. No.: 13/187,022

(22) Filed: Jul. 20, 2011

(51) Int. Cl. H01R 13/02; B05D 1/36; B05D 1/18; C23C 28/02; B05D 5/12

(52) U.S. Cl. 439/886; 205/191; 427/125

(57) ABSTRACT

A method for silver plating an electrical contact is provided. The method includes cleaning an electrical contact by removing oil or other contaminants and exposing the electrical contact to at least one of an acid or base. The method also includes preparing a silver plating bath including a silver compound, a transition metal compound, and a supporting salt, wherein the transition metal is at least one of nickel or cobalt. The method further includes silver plating the electrical contact in the silver plating bath.

### BACKGROUND OF THE INVENTION

The subject matter described herein generally relates to a silver plated electrical contact.

Electrical connectors include electrical contacts that are frequently plated with a metal compound to improve various properties of the electrical contact. For example, plating the contact may improve a coefficient of friction of the contact. As such, less force is required to insert the contact into a corresponding contact. Accordingly, damage to the electrical contact may be avoided. Additionally, plating the electrical contact may improve a durability of the contact thereby reducing wear on the electrical contact and enabling the electrical contact to be used in harsh environments. Moreover, plating the contact may reduce electromigration and tarnishing of the electrical contact.

Typically, electrical contacts are plated with gold. Gold is generally durable and provides a low coefficient of friction, and a low level contact resistance. However gold increases the costs associated with plating the electrical contact. As an alternative to gold, electrical contacts may be plated with silver, which is generally cheaper than gold. However, silver is much softer than gold and provides less durability than gold. Additionally, silver has a high coefficient of friction and is subject to electromigration and tarnishing.

A need remains for a process to plate electrical contacts with hard silver.

### SUMMARY OF THE INVENTION

In one embodiment, a method for silver plating an electrical contact is provided. The method includes cleaning an electrical contact by removing oil or other contaminants and exposing the electrical contact to at least one of an acid or base. The method also includes preparing a silver plating bath including a silver compound, a transition metal compound, and a supporting salt, wherein the transition metal is at least one of nickel or cobalt. The method further includes silver plating the electrical contact in the silver plating bath.

In another embodiment, a silver plated electrical contact is provided. The silver plated contact is formed in a silver plating bath having a silver compound, a transition metal compound, and a supporting salt. The transition metal compound is at least one of nickel or cobalt and forms 0.01 to 5 percent of a content of a silver plated deposit. The supporting salt is at least one of citrate, phosphate, pyrophosphate, acetate, oxalate, or tartrate. The silver plated electrical contact has a grain size of silver that is sub-micron.

### BRIEF DESCRIPTION OF THE DRAWINGS

The presently disclosed subject matter will be better understood from reading the following description of non-limiting embodiments, with reference to the attached drawings, wherein below:

FIG. 1 is a perspective view of a connector formed in accordance with an exemplary embodiment.

FIG. 2 is a flowchart of a method for silver plating an electrical contact in accordance with an embodiment.

FIG. 3 is a flowchart of a method for silver plating an electrical contact in accordance with another embodiment.

FIG. 4 is an exemplary graph of wear cycle versus coefficient of friction in accordance with an embodiment.

FIG. 5 is an exemplary graph of wear cycle versus coefficient of friction in accordance with another embodiment.

FIG. 6 is an exemplary graph of voltage potential versus current density in accordance with an embodiment.

FIG. 7 is an exemplary graph of load force versus resistance in accordance with an embodiment.

### DETAILED DESCRIPTION OF THE DRAWINGS

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Exemplary embodiments described herein include a method for silver plating an electrical contact that includes preparing a silver plating bath including a silver compound, a transition metal compound, and a supporting salt. The electrical contact is silver plated in the silver plating bath. The contact may be silver plated at room temperature or at an elevated temperature. In one embodiment, the transition metal compound is at least one of nickel or cobalt and forms 0.01 to 5 percent of the content in a resulting silver deposit. The supporting salt may be at least one of citrate, phosphate, pyrophosphate, acetate, oxalate or borate. The silver plating bath may include at least one of potassium cyanide, potassium sodium tartrate, an amine group additive or polyethyleneimine (PEI). In one embodiment, the silver plating bath has a concentration of PEI of less than 2000 parts per million, but higher concentration of PEI may work as well. The method may include nickel plating the electrical contact before silver plating the electrical contact. The method may also include silver strike plating the electrical contact after nickel plating the electrical contact and before silver plating the electrical contact. Strike plating forms a thin layer of silver plating that may provide additional adherence to the electrical contact. Accordingly, the strike plating layer may serve as a foundation for subsequent plating processes, such as the silver plating layer. A resultant silver plated electrical contact has a grain size of silver that is sub-micron and has a coefficient of friction between 0.1 and 0.7.

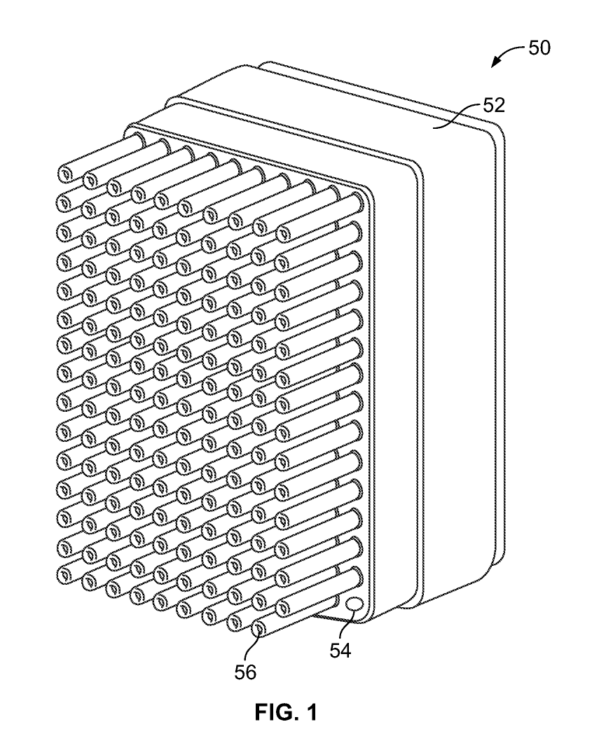

FIG. 1 is a perspective view of a connector 50 formed in accordance with an embodiment. The connector 50 includes a body 52 having a plurality of cavities 54. Electrical contacts 56 are inserted into the cavities 54. The contacts 56 are high-reliability contacts that have been stamped and formed. The contacts 56 are formed for use in applications that require contact durability, for example, military, aircraft, satellite, missile applications, automotive, communications or the like. The contacts 56 are configured to withstand high temperatures, high amounts of shock and vibration, and the like. The contacts 56 are formed from a conductive material, for example, copper. After forming the contacts 56, at least a portion of each contact 56 is covered with a hard silver plating layer to inhibit corrosion, reduce coefficient of friction, reduce contact resistance, and increase durability. Additionally the sliver plating layer may reduce electromigration and tarnishing.

In an exemplary embodiment, the silver plated electrical contact 56 is formed in a silver plating bath having a silver compound, a transition metal compound, and a supporting salt. The transition metal compound may be at least one of nickel or cobalt and may form approximately 0.01 to 5 percent of a content in a resulting silver deposit. The supporting salt may be at least one of citrate, phosphate, pyrophosphate, acetate, oxalate or borate. In one embodiment, the silver plated electrical contact 56 has a grain size of silver that is sub-micron. Additionally, the silver plated electrical contact 56 may have a coefficient of friction between approximately 0.1 and 0.7. The contact 56 may include nickel plating that is plated on the contact 56 before the contact 56 is formed in the silver plating bath. Moreover, the contact 56 may include a silver strike plating that is formed on the contact 56 after the contact 56 is nickel plated and before the contact 56 is silver plated. In one embodiment, the silver plating bath that also includes at least one of an amine group additive or polyethyleneimine (PEI). For example, the silver plating bath may have a concentration of PEI of approximately 2000 parts per million or less.

It should be noted that the connector 50 and the electrical contacts 56 shown in FIG. 1 are exemplary only. The various embodiments described herein may be utilized with any suitable connector and/or electrical contact.

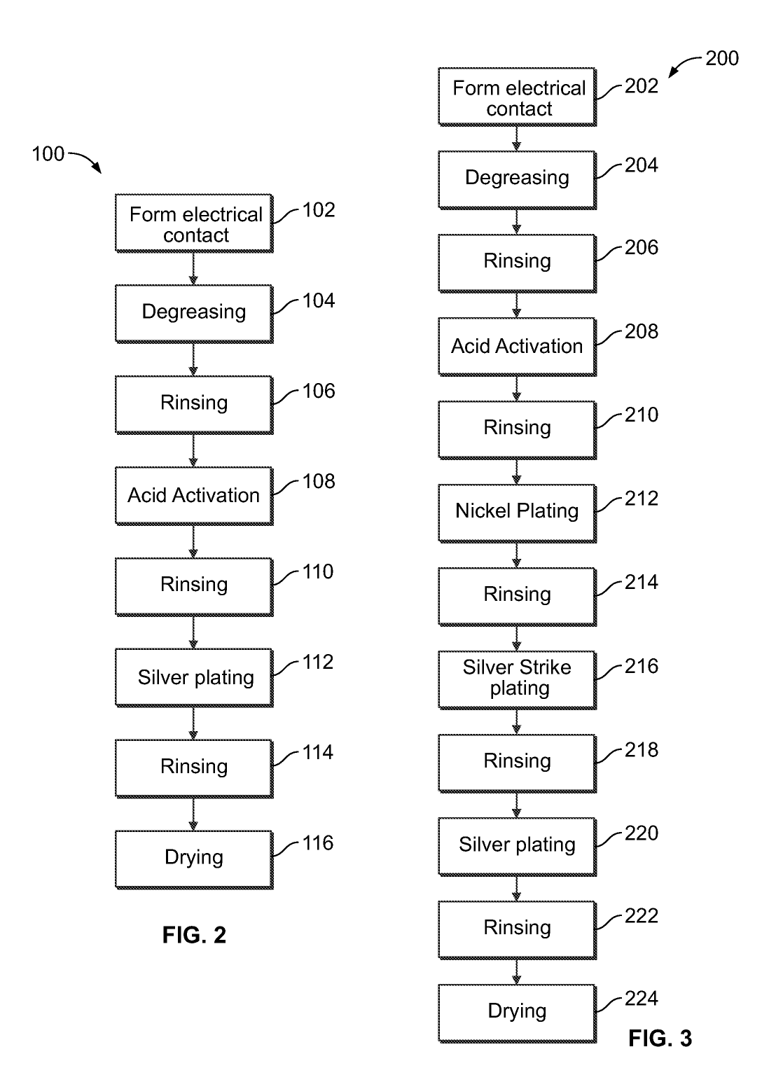

FIG. 2 is a flowchart of a method 100 for silver plating an electrical contact in accordance with an embodiment. At 102, an electrical contact is formed. The electrical contact may be any suitable contact for transmitting electrical signals. The electrical contact may be made from any suitable conductive material, for example, copper or a copper alloy. The electrical contact may be a stamped and formed contact. Alternatively, the electrical contact may be formed using an appropriate die. The electrical contact is configured to have at least a portion thereof silver plated. For example, a mating end of the electrical contact may be configured for silver plating. Optionally, the entire electrical contact may be configured for silver plating.

At 104, the electrical contact is degreased. During degreasing, a chemical may be used to remove oils, such as machining fluids, or other contaminants from the electrical contact. For example, the electrical contact may be degreased using petroleum, chlorine, or alcohol based solvents to dissolve the machining fluids and other contaminants. At 106, the electrical contact is rinsed to remove any degreasing chemicals therefrom. For example, the electrical contact may be rinsed with water.

At 108, the electrical contact undergoes acid activation. The acid activation may be performed with a series of at least one of acids or bases to remove unwanted contaminants from a surface of the electrical contact to reduce poor plating. Additionally, the acid activation may be performed with a weak acid etch or with a proprietary solution. At 110, the electrical contact is rinsed again.

At 112, a sliver plating process is performed. The silver plating process includes preparing a silver plating bath. In an exemplary embodiment, an aqueous silver plating bath is formed having silver, a transition metal compound, and a supporting salt. For example, the silver may be provided as potassium argentocyanide. In one embodiment, the silver plating bath includes approximately 5 gram/Liter (g/L) of silver as potassium argentocyanide. The transition metal compound may be provided as a nickel compound, such as nickel sulfate or nickel carbonate. In one embodiment, the silver plating bath includes approximately 11.6 g/L of nickel as nickel sulfate. Additionally, the supporting salt may be citrate. In one embodiment, the silver plating bath includes approximately 38.4 g/L of sodium citrate. The silver plating bath may also include approximately 26 g/L of potassium cyanide and approximately 28.1 g/L of potassium sodium tartrate. The pH of the silver plating bath may be adjusted to approximately 5.5 using potassium hydroxide. The silver plating process also includes silver plating the electrical contact in the silver plating bath. The silver plating process can be performed in a conventional high-speed, spot, or jet plating process. The silver plating process may be performed at room temperature. Additionally, the silver plating process may be performed at 2 A/dm² for 120 seconds.

In one embodiment, polyethyleneimine (PEI), with a molecular weight of approximately 2000 grams per mole, may be added to the silver plating bath at concentration of 1000 parts per million. The addition of PEI may result in a silver plating deposit having crystalline structure at a sub-micron size range and a lower coefficient of friction. Alternatively, amine group additives, such as 1H-Benzotriazole, and sulfur-bearing organic compounds, such as carbon disulfide and thiosulfate, may be added to the silver plating bath. The amine group additives may be added to the silver plating bath at a targeted concentration of approximately 2000 parts per million or less.

In one embodiment, the transition metal compound may be a cobalt compound, such as cobalt sulfate. For example, the silver plating bath may include approximately 11.6 g/L of cobalt as cobalt sulfate. Moreover, the supporting salt may be at least one of citrate, phosphate, pyrophosphate, acetate, oxalate or borate. The silver plating bath may include approximately 38.4 g/L of supporting salt. Some embodiments of the silver plating bath may include a higher silver content, such as approximately 20 g/L, as potassium argentocyanide.

After the silver plating process, the electrical contact is rinsed, at 114. At 116, the electrical contact is dried. Optionally, the electrical contact may be baked. In one embodiment, the electrical contact may be annealed. For example, the electrical contact may be annealed at 125° C. for 100 hours.

FIG. 3 is a flowchart of a method 200 for silver plating an electrical contact in accordance with another embodiment. At 202 an electrical contact is formed. The electrical contact may be formed as set forth in the method 100 shown in FIG. 2. At 204, the electrical contact is degreased and, at 206, the electrical contact is rinsed to remove any degreasing chemicals therefrom. The electrical contact may be degreased and rinsed as set forth in the method 100 shown in FIG. 2. At 208, the electrical contact undergoes acid activation and, at 210, the electrical contact is rinsed again. The electrical contact may undergo acid activation and be rinsed as set forth in the method 100 shown in FIG. 2.

At 212, the electrical contact undergoes nickel plating. In one embodiment, the electrical contact may be nickel plated using electroplating. Alternatively, the electrical contact may be nickel plated using electroless nickel plating. The nickel plating layers provide additional strength and durability to the electrical contact. The nickel plating process may be performed with nickel and/or nickel alloys. After nickel plating, the electrical contact is rinsed, at 214, as described in method 100 shown in FIG. 1. The nickel plating process may also improve a corrosion resistance of the electrical contact.

At 216, the electrical contact undergoes silver strike plating. Strike plating forms a thin layer of silver plating on the electrical contact. For example, the strike plating layer may be less than approximately 0.1 micrometer thick. The strike plating layer may provide additional adherence to the electrical contact. Accordingly, the strike plating layer may serve as a foundation for subsequent plating processes. In an exemplary embodiment, the strike plating layer forms a foundation for a silver plating layer. After the silver strike plating process, the electrical contact is rinsed, at 218.

At 220, a sliver plating process is performed. The silver plating process includes preparing a silver plating bath. In an exemplary embodiment, an aqueous silver plating bath is formed having silver, a transition metal compound, and a supporting salt. For example, the silver may be provided as potassium argentocyanide. In one embodiment, the silver plating bath includes approximately 5 gram/Liter (g/L) of silver as potassium argentocyanide. The transition metal compound may be provided as a nickel compound, such as nickel sulfate. In one embodiment, the silver plating bath includes approximately 11.6 g/L of nickel as nickel sulfate. Additionally, the supporting salt may be in the form of citrate. In one embodiment, the silver plating bath includes approximately 38.4 g/L of citrate. The silver plating bath may also include approximately 26 g/L of potassium cyanide and approximately 28.1 g/L of potassium sodium tartrate. The pH of the silver plating bath may be adjusted to approximately 5.5 using potassium hydroxide. The silver plating process also includes silver plating the electrical contact in the silver plating bath. The silver plating process can be performed in a conventional high-speed, spot, or jet plating process. The silver plating process may be performed at room temperature. Additionally, the silver plating process may be performed at approximately 2 A/dm² for 120 seconds.

In one embodiment, polyethyleneimine (PEI) may be added to the silver plating bath at the molecular weight range of approximately 600 to 70000 grams per mole. The addition of PEI may result in silver plating deposit having lower coefficient of friction and a crystalline structure at a sub-micron size range. Alternatively, amine group additives, such as 1H-Benzotriazole, and sulfur-bearing organic compounds, such as carbon disulfide and thiosulfate, may be added to the silver plating bath. The amine group additives may be added to the silver plating bath at a concentration of approximately 2000 parts per million or less.

In one embodiment, the transition metal compound may be a cobalt compound, such as cobalt sulfate. For example, the silver plating bath may include approximately 11.6 g/L of cobalt as cobalt sulfate. Moreover, the supporting salt may be at least one of phosphate, pyrophosphate, acetate, or oxalate. The silver plating bath may include approximately 38.4 g/L of supporting salt. Some embodiments of the silver plating bath may include a higher silver content, such as approximately 20 g/L, as potassium argentocyanide.

After the silver plating process, the electrical contact is rinsed, at 222. At 224, the electrical contact is dried to obtain a full hardness of the silver plating. Optionally, the electrical contact may be baked. In one embodiment, the electrical contact may be annealed. For example, the electrical contact may be annealed at approximately 125° C. for approximately 100 hours.

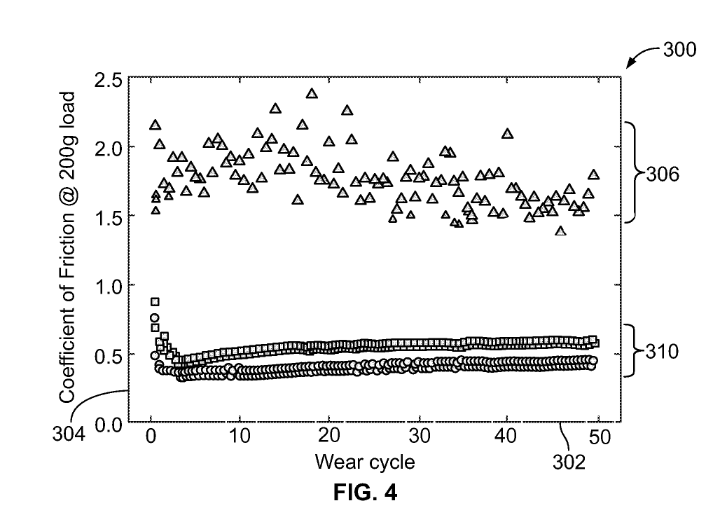

FIG. 4 is an exemplary graph 300 of wear cycle versus coefficient of friction in accordance with an embodiment. The x-axis 302 of the graph 300 illustrates a wear cycle for an electrical contact. The y-axis 304 of the graph 300 illustrates the coefficient of friction of the electrical contact. The graph 300 illustrates the coefficient of friction of the contact over a wear cycle of 50 cycles. The graph 300 also illustrates the coefficient of friction of the contact at a load of 200 g.

A series of points 306 illustrate a coefficient of friction of a pure silver plating over a wear cycle of 50 cycles. As illustrated, the pure silver plating has a coefficient of friction that ranges between approximately 1.5 and 2.5. Additionally, the coefficient of friction declines to a range of approximately 1.5 to 2.0 as the number of cycles increases.

Another series of points 310 illustrates a coefficient of friction of a hard silver plating. In particular, the hard silver plating may be formed in a silver plating bath having a nickel compound, as described above. As illustrated, the hard silver plating has a coefficient of friction within a range of approximately 0.1 to 0.7. Accordingly, plating an electrical contact in a silver bath having a nickel compound significantly decreases the coefficient of friction. Additionally, the coefficient of friction of the hard silver plating is substantially constant. As such, an electrical contact having a plating formed in a silver bath having a nickel compound is capable of withstanding a series of wear cycles without an increase in the coefficient of friction.

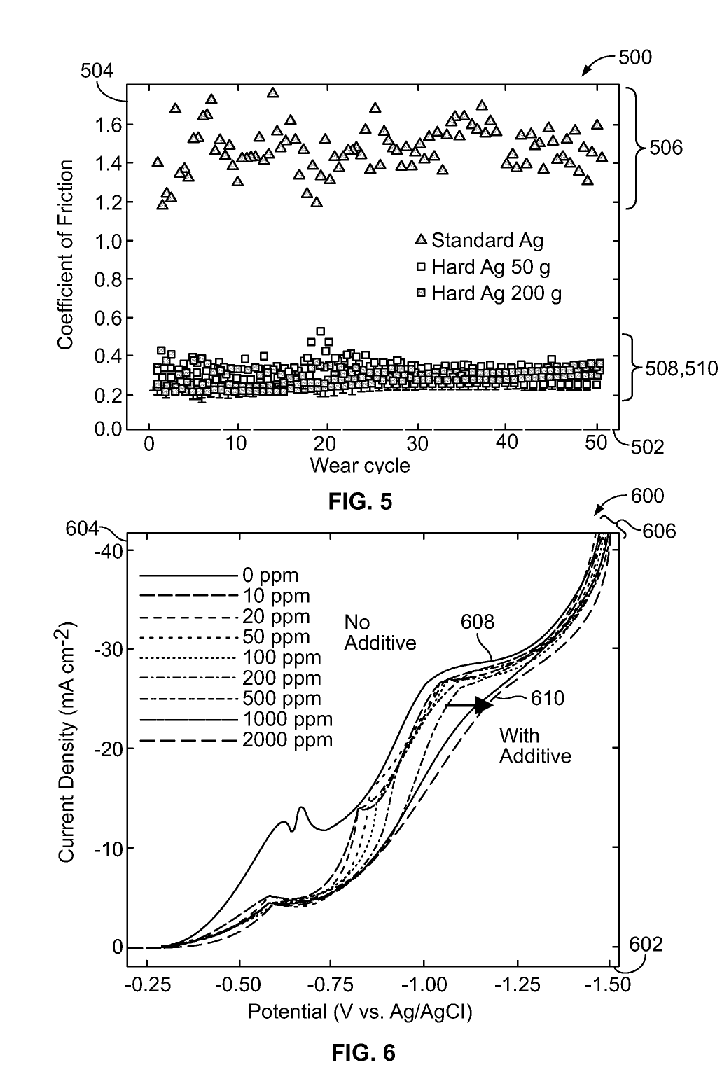

FIG. 5 is an exemplary graph 500 of wear cycle versus coefficient of friction in accordance with an embodiment. The x-axis 502 of the graph 500 illustrates a wear cycle for an electrical contact. The y-axis 504 of the graph 500 illustrates the coefficient of friction of the electrical contact. The graph 500 illustrates the coefficient of friction of the contact over a wear cycle of 50 cycles.

A series of points 506 illustrates the standard coefficient of friction of soft silver. As illustrated, the standard coefficient of friction of soft silver is within a range of approximately 1.2 to 1.7. A series of points 508 illustrates the coefficient of friction of hard silver at a 50 g load. A series of points 510 illustrates the coefficient of friction of hard silver at a 200 g load. As illustrated, the coefficient of friction of hard silver is significantly less than the coefficient of friction of soft silver regardless of the load. In particular, the coefficient of friction of hard silver at either a 50 g load or a 200 g load is within a range of approximately 0.1 to 0.5.

FIG. 6 is an exemplary graph 600 of voltage potential versus current density in accordance with an embodiment. The x-axis 602 illustrates the voltage potential of an electrical contact that is plated with hard silver. The y-axis 604 illustrates the current density of an electrical contact that is plated with hard silver.

A series of lines 606 illustrate the voltage potential versus current density of hard silver platings having varying levels of additive, for example PEI or an amine group. The left-most line 608 illustrates the voltage potential versus current density of a hard silver plating having no additive. Moving right from the line 608, each line represents a greater amount of additive. The right-most line 610 illustrates the voltage potential versus current density of a hard silver plating having 2000 part per million of additive. As illustrated, the additive increases a voltage potential of the electrical contact. Additionally, an amount of additive is substantially proportional to the increase in voltage potential, up to a concentration of 1000 parts per million.

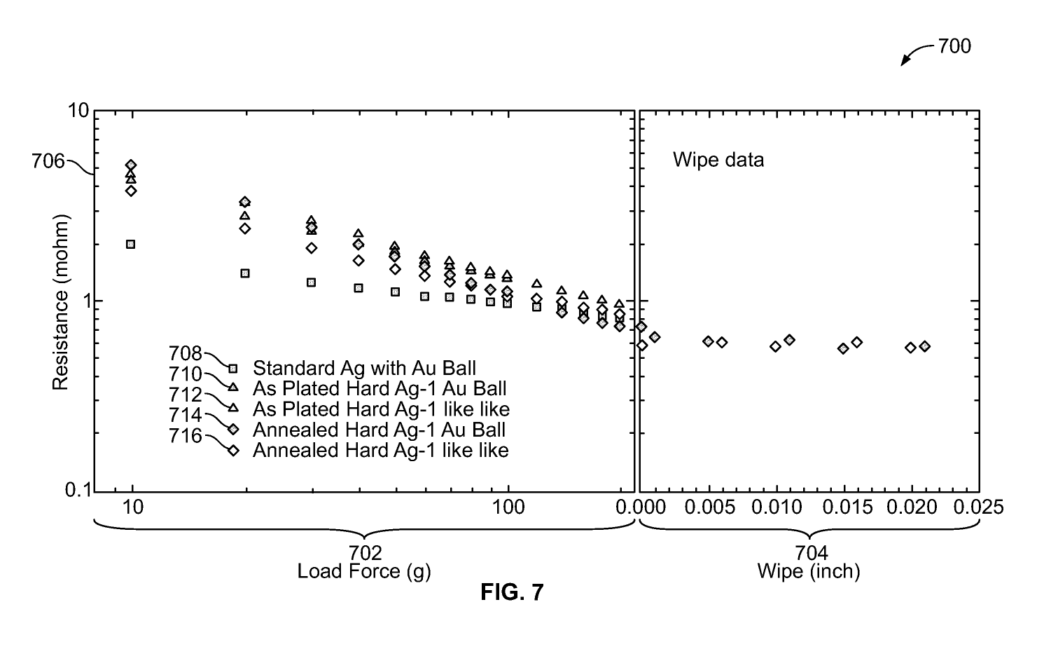

FIG. 7 is an exemplary graph 700 of load force versus resistance in accordance with an embodiment. The graphs 700 also illustrates wipe versus resistance. A portion 702 of the x-axis illustrates load force and another portion 704 of the axis illustrates wipe in inches. The y-axis 706 illustrates resistance. A series of points 708 illustrate a standard silver plated copper ball. A series of points 710 illustrate a hard silver plated copper ball. A series of points 712 illustrate hard silver plating. A series of points 714 illustrate an annealed silver plated copper ball. A series of points 716 illustrate annealed silver plating.

The various embodiments provide a plating methodology to plate hard silver as a replacement material for gold. For example, the hard plating methodology may be used in low normal, tight centerline applications where gold is the norm. The various embodiments provide cost savings for products that are typically gold plated. Additionally, the various embodiments may be used to extend the use of silver beyond the power and auto industry to uses in harsher conditions. The various embodiments provide the chemistry and processes to achieve hard silver using electroplating to produce a hard silver having a relatively low coefficient of friction (e.g. 0.1-0.7) and good wearability.

In one embodiment cobalt may be used instead of nickel to achieve similar results. Additionally, a wide range of plating rates can give deposits with similar properties. A higher plating rate may be used on solutions with higher silver and nickel concentration. Additives, other than PEI, with amine groups may improve deposit quality, in terms of changing morphology and reducing coefficient of friction. Silver plating bath solutions, with a PEI content from 0 to 2000 parts per million may give better silver deposits compared with conventional silver. In one embodiment, a striking solution may be used to improve the adhesion of a silver layer on nickel. The silver striking solution may be based on a cyanide chemistry or noncyanide chemistry.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for silver plating an electrical contact comprising:
cleaning the electrical contact by removing oil or other contaminant and exposing the electrical contact to at least one of an acid or base;
preparing a silver plating bath including a silver compound, a transition metal compound, and a supporting salt, the transition metal being at least one of nickel or cobalt.
silver plating the electrical contact in the silver plating bath.

2. The method of claim 1 further comprising nickel plating the electrical contact before silver plating the electrical contact.

3. The method of claim 2 further comprising silver strike plating the electrical contact after nickel plating the electrical contact and before silver plating the electrical contact.

4. The method of claim 1 further comprising preparing the silver plating bath with potassium cyanide.

5. The method of claim 1 further comprising preparing the silver plating bath with a complexing agent.

6. The method of claim 1 further comprising preparing the silver plating bath with polyethylenimine (PEI).

7. The method of claim 5 further comprising preparing the silver plating bath with a concentration of PEI of approximately 2000 parts per million or less.

8. The method of claim 1 further comprising preparing the silver plating bath with an additive having a carbon chain and an amine group.

9. The method of claim 1 further comprising preparing the silver plating bath with a supporting salt that is at least one of citrate, phosphate, pyrophosphate, acetate, oxalate, or tartrate.

10. The method of claim 1 further comprising forming an electrical contact.

11. The method of claim 1, wherein the silver plating the electrical contact is performed at room temperature.

12. The method of claim 1, wherein the transition metal compound content of the silver plating bath is between approximately 0.01 and 5 percent.

13. A silver plated electrical contact formed in a silver plating bath having a silver compound, a transition metal compound, and a supporting salt, the transition metal compound being at least one of nickel or cobalt and forming approximately 0.01 to 5 percent of a content of a silver plated deposit, the supporting salt being at least one of citrate, phosphate, pyrophosphate, acetate, oxalate, or tartrate, the silver plated electrical contact having a grain size of silver that is sub-micron.

14. The silver plated electrical contact of claim 13, wherein the contact has a coefficient of friction between approximately 0.1 and 0.7 in an as plated and annealed condition at a dry state.

15. The silver plated electrical contact of claim 13 further comprising a nickel plating that is plated on the contact before the contact is formed in the silver plating bath.

16. The silver plated electrical contact of claim 15 further comprising a silver strike plating that is formed on the contact after the contact is nickel plated and before the contact is silver plated.

17. The silver plated electrical contact of claim 13, wherein the contact is formed in a silver plating bath further having polyethyleneimine (PEI).

18. The silver plated electrical contact of claim 13, wherein the contact is formed in a silver plating bath further having an additive including a carbon chain and an amine group.

19. The silver plated electrical contact of claim 13, wherein the contact is formed from copper plated in the silver plating bath.

20. The silver plated electrical contact of claim 13, wherein the electrical contact is silver-plated at room temperature.
